(19) United States
(12) Patent Application Publication
(10) Pub. No.: US 2023/0029939 A1
(43) Pub. Date: Feb. 2, 2023

(54) ELECTRIC DRIVE SYSTEM FOR A VEHICLE

(71) Applicants: Transportation IP Holdings, LLC, Norwalk, CT (US); Komatsu America Corp., Chicago, IL (US); Cummins Inc., Columbus, IN (US)

(72) Inventors: Henry Todd Young, Erie, PA (US); Rekha Doddarangaiah Prasad, Warrendale, PA (US); David John Scott, Washington, IL (US); Timothy Robert Heller, Germantown Hills, IL (US); Paul Wiczynski, Columbus, IN (US); Phanindra Garimella, Bloomington, IN (US)

(21) Appl. No.: 17/876,310

(22) Filed: Jul. 28, 2022

Related U.S. Application Data
(60) Provisional application No. 63/228,456, filed on Aug. 2, 2021.

(51) Int. Cl. B60W 20/11; B60W 10/06; B60W 10/08; B60W 20/19

(52) U.S. Cl. CPC B60W 20/11; B60W 10/06; B60W 10/08; B60W 20/19; B60W 2520/10; B60W 2710/0666; B60W 2510/0666

(57) ABSTRACT

An electric drive system for a vehicle and method includes controlling a propulsion system of the vehicle to operate according to a first torque-speed relationship between a power generated by an engine and a speed of the engine. The engine is controlled according to the first torque-speed relationship during acceleration of the vehicle by motors that are powered by operation of the engine. The method includes determining that operation of the propulsion system has reached a steady state following the propulsion system operating according to the first torque-speed relationship and controlling the propulsion system to operate according to a second torque-speed relationship between the power and the speed of the engine. The second torque-speed relationship is reduced relative to the first torque-speed relationship such that the engine speed in the first torque-speed relationship is associated with a greater amount of power than in the second torque-speed relationship.

### CROSS-REFERENCE TO RELATED APPLICATIONS

This application claims priority to U.S. Provisional Application No. 63/228,456 (filed 2 Aug. 2021), the entire disclosure of which is incorporated herein by reference.

### BACKGROUND

### Technical Field

The subject matter described herein relates to a propulsion system having an electric drive system and related method.

### Discussion of Art

Vehicles carrying cargo are operated at a power-to-engine speed ratio that optimizes an amount of fuel consumption by the vehicle. For example, a vehicle propulsion system may be operated at settings that optimize fuel efficiency while sacrificing an amount of power generated by the system. However, operating at the reduced speed may increase an amount of time for the system to reach a target power output. For example, it may take a greater amount of time for a propulsion system operating at settings that consume a reduced amount of fuel to reach a full power output relative to a system operating at settings that consume an increased amount of fuel. Operating the system to optimize the fuel efficiency of the drive system compromises the response time of the system (e.g., a haul cycle time). Alternatively, operating the system to increase the response time (e.g., complete a haul cycle in a shorter amount of time) compromises the fuel efficiency of the system. It may be desirable to have a system and method that differs from those that are currently available.

### BRIEF DESCRIPTION

In one or more embodiments, a method includes controlling a propulsion system of a vehicle to operate according to a first torque-speed relationship between a power generated by an engine of the propulsion system and a speed of the engine. The engine may be controlled according to the first torque-speed relationship during acceleration of the vehicle by one or more motors that are powered by operation of the engine. The method may include determining that operation of the propulsion system has reached a steady state following the propulsion system operating according to the first torque-speed relationship. The propulsion system may be controlled to operate according to a second torque-speed relationship between the power generated by the engine and the speed of the engine. The second torque-speed relationship may be reduced relative to the first torque-speed relationship such that the engine speed in the first torque-speed relationship is associated with a greater amount of power than in the second torque-speed relationship.

In one or more embodiments, a method includes controlling a propulsion system of a vehicle to operate according to a first torque-speed relationship between a power generated by an engine of the propulsion system and a speed of the engine. The propulsion system may be controlled according to the first torque-speed relationship during acceleration of the vehicle by one or more motors that are powered by operation of the propulsion system. The method may include determining one or more of a rate of acceleration of the vehicle, that the propulsion system has been operated for a predetermined amount of time, or that operation of the propulsion system has reached a steady state following the propulsion system operating according to the first torque-speed relationship. The propulsion system may be controlled to operate according to a second torque-speed relationship between the power generated by the engine and the speed of the engine based on determining the one or more of the rate of acceleration of the vehicle, that the propulsion system has been operated for the predetermined amount of time, or that operation of the propulsion system has reached the steady state. The second torque-speed relationship may be reduced relative to the first torque-speed relationship such that the engine speed in the first torque-speed relationship is associated with a greater amount of power than in the second torque-speed relationship.

In one or more embodiments, a vehicle control system includes a controller having one or more processors configured to control a propulsion system of a vehicle to operate according to a first torque-speed relationship between a power generated by an engine of the propulsion system and a speed of the engine. The controller may control the propulsion system to operate according to the first torque-speed relationship during acceleration of the vehicle system by one or more motors that are powered by operation of the propulsion system. The one or more processors may determine that operation of the propulsion system has reached a steady state following the propulsion system operating according to the first torque-speed relationship. The controller may control the propulsion system to operate according to a second torque-speed relationship between the power generated by the engine and the speed of the engine. The second torque-speed relationship may be reduced relative to the first torque-speed relationship such that the engine speed in the first torque-speed relationship is associated with a greater amount of the power than in the second torque-speed relationship.

### BRIEF DESCRIPTION OF THE DRAWINGS

The inventive subject matter may be understood from reading the following description of non-limiting embodiments, with reference to the attached drawings, wherein below:

FIG. 1 illustrates one example of an electric drive system;

FIG. 2 illustrates a flowchart of one example of a method for controlling a drive system of a powered system; and

FIG. 3 illustrates examples of power curves for the engine of the powered system shown in FIG. 1.

### DETAILED DESCRIPTION

Embodiments of the subject matter described herein relate to a propulsion system and method of operation. The propulsion system may include an electric drive system. The method may control the vehicle, the electric drive, and/or aspects of the engine as a result of the needs of the electric drive system. The propulsion system may be controlled to operate according to one or more different torque-speed relationships between a torque generated by the engine of the propulsion system and a speed of the engine. For example, the engine may be controlled according to different torque-speed relationships based on conditions of the vehicle or systems of the vehicle, based on different operating conditions (e.g., during acceleration, deceleration, cruise, or the like), based on ambient conditions of the vehicle (e.g., temperature, elevation, ground conditions, grade on which the vehicle moves, or the like), based on a location of the vehicle, vehicle system health, a temperature of one or more systems or components of the vehicle, or the like. Operating the propulsion system according to different torque-speed relationships may increase some efficiencies of the overall system, such as operating the engine at a lower speed while generating substantially a same amount of torque (e.g., by reducing an operating load on the system thereby consuming less fuel).

The different torque-speed relationships at which that the propulsion system may be operated allows the vehicle to switch between different torque curves to allow flexibility and/or adaptability of the propulsion system. The propulsion system may switch between being operated according to a first torque-speed relationship and a different second torque-speed relationship based on the environment conditions, operational conditions, and/or vehicle system conditions.

In one embodiment, the first torque-speed relationship may optimize a fuel economy of the system for an equivalent power in the second torque-speed relationship. For example, the propulsion system may adjust the engine speed and resulting power generated by the propulsion system to provide increased or faster acceleration during transient operation of the vehicle (e.g. while the propulsion is operated according to a first torque-speed relationship), and additionally may adjust the engine speed and resulting power to optimize fuel efficiency of the propulsion system during steady state operation of the vehicle (e.g., while the propulsion system is still operated according to a first torque-speed relationship for a substantially equivalent power in the second torque-speed relationship). For example, the propulsion system may reach a steady state in a reduced amount of time by controlling the system at an increased power level allowed by the first torque-speed relationship relative to controlling the system according to the second torque-speed relationship. Additionally, the system may consume an increased amount of fuel at the increased power level of the first torque-speed relationship by controlling the system according to the first torque-speed relationship relative to controlling the system according to the second torque-speed relationship.

The steady state of the propulsion system may be based on one or more conditions of the propulsion system and/or the vehicle. Operation of the propulsion system may reach a steady state responsive to the vehicle reaching a predetermined target acceleration, responsive to the drive system achieving a predetermined amount of generated power, responsive to the system achieving a target engine speed, responsive to the vehicle achieving a predetermined speed of travel, responsive to the engine maintaining a predetermined engine speed and with a corresponding load on the propulsion system reaching a predetermined level, or any combination therein.

In one embodiment, a controller onboard and/or off-board the vehicle may automatically control the system to operate according to one or more of the different torque-speed relationships. For example, the controller may determine whether the propulsion system should be operated according to the first or second torque-speed relationship based on one or more conditions of the vehicle, conditions and/or characteristics of systems onboard the vehicle, based on an amount of time the system has been operated in one of the torque-speed relationships, based on a determined amount of available fuel, or the like. Optionally, the controller may control the system to switch operating conditions responsive to the propulsion reaching a steady state or a steady state condition, reaching and maintain the steady state operating condition for a predetermined condition (e.g., a length of time, a distance of travel, or the like), responsive to the propulsion system operating according to a torque-speed relationship for a predetermined amount of time, responsive to a rate of acceleration of the vehicle meeting or reaching a predetermined threshold, or the like. Additionally or alternatively, an operator onboard and/or off-board the vehicle may manually control the propulsion system to operate according to one or more different torque-speed relationships. In one embodiment, the controller or a control system may communicate notification to the operator directing the operator to switch between operating conditions.

The controller also can determine whether operation of the propulsion system has not reached a steady state, that the propulsion system has not been operated according to one torque-speed relationship for a predetermined amount of time or a designated threshold amount of time, that the vehicle has not reached a predetermined rate of acceleration, or the like. For example, the controller may determine that the propulsion system has not yet reached a steady state, and may determine that the propulsion system should continue to be operated according to the first torque-speed relationship. In one embodiment, the controller may determine that the system should be operated to a different, third torque-speed relationship that may reach the steady state faster than operating the system according to the first torque-speed relationship, or that the vehicle may reach the predetermined rate of acceleration faster than by continuing to operate the system according to the first torque-speed relationship.

In one embodiment, the drive system may have a local data collection system deployed that may use machine learning to enable derivation-based learning outcomes. The drive system may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

The drive system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The drive system may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The drive system can use this artificial intelligence or machine learning to receive input (e.g., operating characteristics of the vehicle), use a model that associates different operating characteristics with different headroom targets to select a new or different headroom target, and then provide an output (e.g., the new or different headroom target). The drive system may receive additional input (e.g., new or different operating characteristics, operator input, or the like), that indicates whether the machine-selected headroom target provided a desirable outcome or not. Based on this additional input, the drive system can change the model, such as by changing which headroom target would be selected when a similar or identical operating characteristics are received the next time or iteration. The drive system can then use the changed or updated model again to select a headroom target, receive feedback on the selected headroom target, change or update the model again, etc., in additional iterations to repeatedly improve or change the model using artificial intelligence or machine learning.

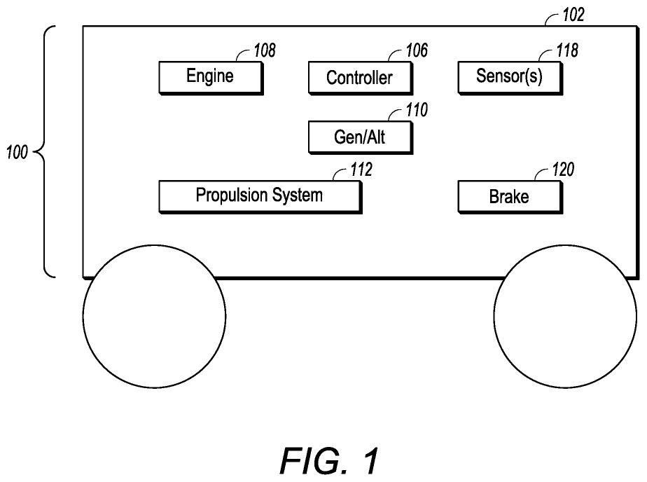

FIG. 1 illustrates one example of an electric drive system 100. The drive system is shown onboard a powered system 102, such as a mining vehicle or a heavy haul vehicle. The drive system may include a controller 106 that represents hardware circuitry having and/or connected with one or more processors, such as one or more microprocessors, field programmable gate arrays, integrated circuits, and/or the like. In one embodiment, the controller can represent an engine control unit. The controller communicates with an engine 108 of the powered system. This engine can be a fuel-consuming engine, such as a diesel engine. Not all embodiments of the inventive subject matter, however, are limited to diesel engines. The engine can represent another type of engine that consumes fuel other than diesel fuel.

The engine consumes fuel to perform work, such as rotating a shaft joined to a generator or alternator 110 (“Gen/Alt” in FIG. 1), which causes the generator or alternator to output electric current. This current can be stored or provided to one or more powered components of the powered system, such as a propulsion system 112 and/or an auxiliary system (not shown). The propulsion system can represent one or more motors that propel the powered system (e.g., traction motors) using electric current output by the generator or alternator. The auxiliary system can represent one or more other loads that consume at least some of this current, but not for propulsion of the powered system. For example, the auxiliary system can represent fans (e.g., blowers that cool parts of the propulsion system, blowers that cool braking resistors, pumps that force coolant to cool the engine or other components, etc.), heating and/or cooling systems that heat or cool an operator cab of the powered system, or the like. Optionally, the propulsion system can represent a first group of one or more components that are powered by at least some of the current output by the generator or alternator and the auxiliary system can represent a separate, different second group of one or more components that also are powered by at least some of the current output by the generator or alternator.

One or more sensors 118 of the drive system may sense characteristics of operation of the powered system and/or environment, and may output signals (e.g., wireless signals and/or signals that are conducted via one or more conductive pathways such as wires, cables, buses, etc.). As described herein, the controller can receive these characteristics to monitor the operation and/or environment of the powered system. Using this information, the controller can change one or more operations of the powered system, such as, but not limited to, an operating speed of the engine, a brake setting, or the like. The number of each of the components shown in FIG. 1 is used as one example. For example, multiples of the engine, the controller, the sensor(s), the generator, the alternator, and/or the propulsion system may be provided.

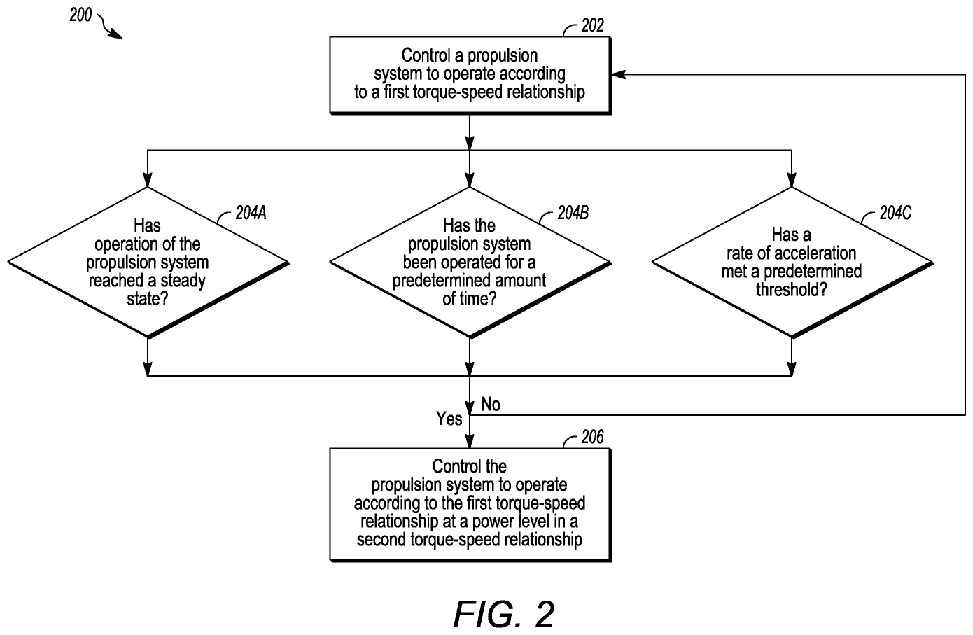

With reference to the drive system shown in FIG. 1, FIG. 2 illustrates a flowchart of one example of a method 200 for controlling a drive system of a powered system. The operations described in connection with the method can be performed by the controller unless otherwise described herein.

At 202, the propulsion system is controlled to operate according to a first torque-speed relationship. The first torque speed relationship may represent a relationship between a torque generated by the engine and a speed of the engine. In one embodiment, the engine is controlled according to the first torque-speed relationship during acceleration of the vehicle by the one or more motors that are powered by operation of the engine.

The method continues to one or more of 204A, 204B, or 204C. At 204A, a determination is made to whether operation of the propulsion system has reached a steady state. At 204B, it is determined whether the propulsion system has been operated according to the first torque-speed relationship for a predetermined threshold amount of time. At 204C, it is determined whether a rate of acceleration of the vehicle has reached a predetermined threshold. In one or more embodiments, the one or more sensors may output signals indicative of one or more vehicle characteristics, characteristics of the propulsion system or another system of the vehicle, environmental conditions, or the like. The controller may receive the output signals of the one or more sensors and may determine whether at least one of steps 204A-C has been achieved. For example, the one or more sensors may be accelerometers, tachometers, cameras, or the like, that may output signals indicative of a speed of the engine or the travel speed of the vehicle. The controller may determine that a rate of acceleration of the engine has reached a predetermined threshold or that acceleration of the vehicle has reached a predetermined threshold or threshold range, and therefore determine that at least step 204C has been achieved.

In one or more embodiments, responsive to at least one of the steps 204A-C being achieved, flow of the method proceeds toward 206. Optionally, flow of the method may proceed toward 206 responsive to at least two of the steps 204A-C being achieved. Optionally, flow may proceed toward 206 responsive to all of steps 204A-C being achieved.

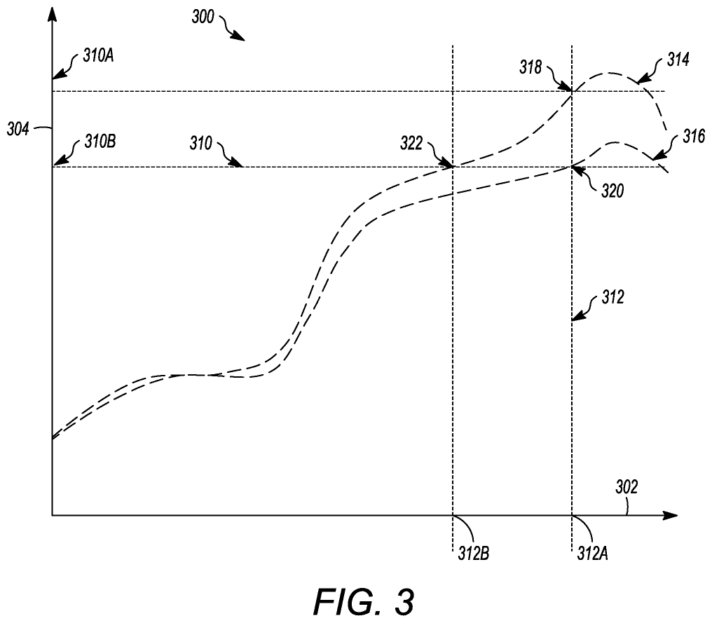

FIG. 3 illustrates examples of power curves 300 for the engine of the powered system shown in FIG. 1. The power curves are shown alongside a horizontal axis 302 representative of different speeds of the engine and a vertical axis 304 representative of different power output by the engine (at the corresponding engine speeds). A first power curve 314 associated with a first torque-speed relationship, and a second power curve 316 associated with a second torque-speed relationship. The controller can control the propulsion system to operate according to the first torque-speed relationship, according to the second torque-speed relationship, or according to one or more other torque-speed relationships. The propulsion system may operate according to the first torque-speed relationship during acceleration, and may continue to operate according to the first torque-speed relationship (e.g., a reduced engine speed for the same power relative to the second torque-speed relationship) responsive to the propulsion system reaching a steady state of operation.

The controller can refer to the different torque-speed relationships (e.g., the first and second torque curves) to determine to which speed the engine can be reduced to while the propulsion system generates a substantially same amount of power. For example, a power output 310 may indicate an amount of power the propulsion system generates. The engine may operate at different speeds 312 (e.g., 312A, 312B) while providing the requested power output of the vehicle. Additionally, the propulsion system may generate different amounts of power 310 (e.g., 310A, 310B) while operating at different engine speeds. The controller may control the propulsion system to operate according to the first torque-speed relationship at a first speed 312A while generating a first amount of power 310A, indicated by a point 318.

Returning to FIG. 2, responsive to determining that the propulsion system has reached the steady state (e.g., at least the step 204A), flow of the method may proceed toward 206. At 206, the controller controls operation of the system to operate according to the first torque-speed relationship at an equivalent power in the second torque-speed relationship. For example, the controller may control the propulsion system to operate according to the power indicated by point 322 on the first torque-speed relationship which is substantially equal (e.g., within 1% of, within 10% of, within 25% of, or the like) to the power indicated by point 320 on the second torque-speed relationship but at a new reduced speed indicated by 312B.

The propulsion system operating according to the first torque-speed relationship is associated with a first amount of power 310A that is greater than a second amount of power 310B in the second torque-speed relationship. For example, the point 318 indicates the propulsion system generates a greater amount of power (310A) while operating according to the first torque-speed relationship relative to the point 320 indicating the system operating according to the second torque-speed relationship at a lower amount of power at the same, or substantially the same, engine speed.

In one or more embodiments, a speed of movement of the vehicle may limited to a designated speed threshold while the propulsion system is operated according to the first torque-speed relationship. For example, the speed of the vehicle may be limited due to legal restrictions, vehicle capabilities, or the like, and while the propulsion system is operated according to the first torque-speed relationship, the speed of movement of the vehicle may be limited to a predetermined speed threshold or limit.

In one or more embodiments, the controller may control operation of the propulsion system to operate at a second engine speed 312B of the first torque-speed relationship. The second engine speed of the first torque-speed relationship is indicated by a point 322. For example, the first engine speed 312A in the first torque-speed relationship is greater than the second engine speed 312B in the first torque-speed relationship. Additionally, the first engine speed in the first torque-speed relationship is associated with a greater amount of power than the second engine speed in the first torque-speed relationship.

The system operating according to the first torque-speed relationship at the second engine speed (e.g., the point 322) is associated with substantially a same amount of power as the system operating according to the second torque-speed relationship at the first engine speed (e.g., the point 320). For example, the propulsion system may reduce the speed of the engine from the first speed 312A to the second speed 312B while generating a same amount of power between the first torque-speed relationship and the second torque-speed relationship.

Returning to FIG. 2, responsive to determining that none of the steps 204A-C have been achieved, flow of the method returns to 202 and the propulsion system continues to be operated according to the first torque-speed relationship.

Alternatively, responsive to determining that at least one of the steps 204A-C has been achieved, flow of the method proceeds toward 206. At 206, the propulsion system is controlled according to the first torque-speed relationship at the power level 310B set by the second torque-speed relationship at the first engine speed 312A In one or more embodiments, the controller may automatically control the propulsion system to change between operating according to the first torque-speed relationship and operating according to the second torque-speed relationship. The system determines when to operate according to the second torque-speed relationship based on vehicle system health, environmental conditions, or the like. Optionally, the propulsion system may be controlled to operate according to the first torque-speed relationship at the second speed 312B, and the engine operating at the second engine speed is configured to generate an equivalent amount of power associated with the second torque-speed relationship. Flow of the method may continue while the vehicle is in operation, while the vehicle moves along the route, until the vehicle reaches a destination, for a predetermined amount of time, or the like.

In one or more embodiments, the controller can operate the propulsion system of the drive system to operate at a first setting (e.g., first torque-speed relationship) to increase the power of the vehicle (e.g., the engine speed and the drive system power) to a first target value to provide a faster engine acceleration, faster power build up, and faster vehicle acceleration, relative to the propulsion system operating at a second setting (e.g., the second torque-speed relationship). Responsive to the propulsion system reaching a steady state of operation, the controller can operate the propulsion system at the second setting that includes reducing an engine speed and corresponding extracted power, thereby improving the fuel efficiency of the system relative to operating at the first setting. For example, the drive system may control the propulsion system to operate according to the first torque-speed relationship (e.g., the increased power curve) and adjust the engine speed and power to improve fuel efficiency of the drive system while substantially maintaining the performance that the propulsion system operating according to the second torque-speed relationship (e.g., the lower power curve) would provide at the increased engine speed. The controller can dynamically change between operating according to the first torque-speed relationship or operating according to the second torque-speed relationship responsive to predetermined conditions being met, based on environmental conditions, or the like.

In one embodiment, a method includes controlling a propulsion system of a vehicle to operate according to a first torque-speed relationship between a power generated by an engine of the propulsion system and a speed of the engine. The engine is controlled according to the first torque-speed relationship during acceleration of the vehicle by one or more motors that are powered by operation of the engine. The method includes determining that operation of the propulsion system has reached a steady state following the propulsion system operating according to the first torque-speed relationship. The propulsion system is controlled to operate according to a second torque-speed relationship between the power generated by the engine and the speed of the engine. The second torque-speed relationship is reduced relative to the first torque-speed relationship such that the engine speed in the first torque-speed relationship is associated with a greater amount of power than in the second torque-speed relationship.

The propulsion system may be controlled to operate at a second engine speed of the first torque-speed relationship responsive to determining that operation of the propulsion system has reached the steady state. The second engine speed of the first torque-speed relationship is associate with a same amount of power as in the second torque-speed relationship.

Determining that operation of the propulsion system has reached the steady state may include determining that acceleration of the vehicle has reached a predetermined threshold range. The propulsion system may be configured to reach the steady state in a reduced amount of time by controlling the propulsion system according to the first torque-speed relationship relative to controlling the propulsion system according to the second torque-speed relationship. The first engine speed in the first torque-speed relationship is greater than a second engine speed in the first torque-speed relationship, and the first engine speed in the first torque-speed relationship is associated with a greater amount of the power than the second engine speed in the first torque-speed relationship. The method may include determining one or more of a rate of acceleration of the vehicle or if the propulsion system has been operated according to the first torque-speed relationship for a predetermined amount of time. The method may include determining that the propulsion system has been operated according to the first torque-speed relationship for a predetermined amount of time, and controlling the propulsion system to operate according to the first torque-speed relationship at a second engine speed. The engine operating at the second engine speed is configured to generate a same amount of power associated with the second torque-speed relationship. A speed of movement of the vehicle may be limited to a designated speed threshold while the propulsion system is operated according to the first torque-speed relationship. The method may include automatically controlling the propulsion system to operate according to the first torque-speed relationship of according to the second torque-speed relationship. The method may include determining one or more conditions of the vehicle and controlling the propulsion system to operate according to the first torque-speed relationship or according to the second torque-speed relationship based on the one or more of the conditions of the vehicle.

In one embodiment, a method may include controlling a propulsion system of a vehicle to operate according to a first torque-speed relationship between a power generated by an engine of the propulsion system and a speed of the engine. The propulsion system may be controlled according to the first torque-speed relationship during acceleration of the vehicle by one or more motors that are powered by operation of the propulsion system. The method may include determining one or more of a rate of acceleration of the vehicle, that the propulsion system has been operated for a predetermined amount of time, or that operation of the propulsion system has reached a steady state following the propulsion system operating according to the first torque-speed relationship. The propulsion system may be controlled to operate according to a second torque-speed relationship between the power generated by the engine and the speed of the engine based on determining the one or more of the rate of acceleration of the vehicle, that the propulsion system has been operated for the predetermined amount of time, or that operation of the propulsion system has reached the steady state. The second torque-speed relationship may be reduced relative to the first torque-speed relationship such that the engine speed in the first torque-speed relationship is associated with a greater amount of power than in the second torque-speed relationship.

The method may include controlling the propulsion system to operate at a second engine speed of the first torque-speed relationship responsive to determining the one or more of the rate of acceleration of the vehicle, that the propulsion system has been operated for the predetermined amount of time, or that operation of the propulsion system has reached the steady state. The second engine speed of the first torque-speed relationship is associated with a same amount of the power as in the second torque speed relationship. The propulsion system may reach the steady state in a reduced amount of time by controlling the propulsion system according to the first torque-speed relationship relative to controlling the propulsion system according to the second torque-speed relationship. The engine speed in the first torque-speed relationship is greater than a second engine speed in the first torque-speed relationship, and the engine speed in the first torque-speed relationship is associated with a greater amount of the power than the second engine speed in the first torque-speed relationship. A speed of movement of the vehicle may be limited to a designated speed threshold while the propulsion system is operated according to the first torque-speed relationship. The method may include automatically controlling the propulsion system to operate according to the first torque-speed relationship or according to the second torque-speed relationship. The method may include determining one or more conditions of the vehicle, and controlling the propulsion system to operate according to the first torque-speed relationship or the second torque-speed relationship based on the one or more conditions of the vehicle.

In one embodiment, a vehicle control system may include a controller having one or more processors configured to control a propulsion system of a vehicle to operate according to a first torque-speed relationship between a power generated by an engine of the propulsion system and a speed of the engine. The controller may control the propulsion system to operate according to the first torque-speed relationship during acceleration of the vehicle system by one or more motors that are powered by operation of the propulsion system. The one or more processors may determine that operation of the propulsion system has reached a steady state following the propulsion system operating according to the first torque-speed relationship. The controller may control the propulsion system to operate according to a second torque-speed relationship between the power generated by the engine and the speed of the engine. The second torque-speed relationship may be reduced relative to the first torque-speed relationship such that the engine speed in the first torque-speed relationship is associated with a greater amount of the power than in the second torque-speed relationship.

The one or more processors may determine that the propulsion system has been operated according to the first torque-speed relationship for a designated threshold amount of time, and the controller may control the propulsion system to operate according to the second torque-speed relationship. The controller may automatically control the propulsion system to operate according to the first torque-speed relationship or according to the second torque-speed relationship. The controller may control the propulsion system to operate at a second engine speed of the first torque-speed relationship responsive to determining that operation of the propulsion system has reached the steady state. The second engine speed of the first torque-speed relationship may be associated with a same amount of power as in the second torque-speed relationship.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and clauses, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and clauses, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The clauses define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
controlling a propulsion system of a vehicle to operate according to a first torque-speed relationship between a power generated by an engine of the propulsion system and a speed of the engine, the engine controlled according to the first torque-speed relationship during acceleration of the vehicle by one or more motors that are powered by operation of the engine;
determining that operation of the propulsion system has reached a steady state following the propulsion system operating according to the first torque-speed relationship; and
controlling the propulsion system to operate according to a second torque-speed relationship between the power generated by the engine and the speed of the engine, the second torque-speed relationship reduced relative to the first torque-speed relationship such that the engine speed in the first torque-speed relationship is associated with a greater amount of the power than in the second torque-speed relationship.

2. The method of claim 1, further comprising controlling the propulsion system to operate at a second engine speed of the first torque-speed relationship responsive to determining that operation of the propulsion system has reached the steady state, wherein the second engine speed of the first torque-speed relationship is associated with a same amount of the power as in the second torque-speed relationship.

3. The method of claim 1, wherein determining that operation of the propulsion system has reached the steady state includes determining that acceleration of the vehicle has reached a predetermined threshold range.

4. The method of claim 1, wherein the propulsion system is configured to reach the steady state in a reduced amount of time by controlling the propulsion system according to the first torque-speed relationship relative to controlling the propulsion system according to the second torque-speed relationship.

5. The method of claim 1, wherein the first engine speed in the first torque-speed relationship is greater than a second engine speed in the first torque-speed relationship, and the first engine speed in the first torque-speed relationship is associated with a greater amount of the power than the second engine speed in the first torque-speed relationship.

6. The method of claim 1, further comprising determining one or more of a rate of acceleration of the vehicle or if the propulsion system has been operated according to the first torque-speed relationship for a predetermined amount of time.

7. The method of claim 1, further comprising:
determining that the propulsion system has been operated according to the first torque-speed relationship for a designated threshold amount of time; and
controlling the propulsion system to operate according to the first torque-speed relationship at a second engine speed, the engine operating at the second engine speed configured to generate a same amount of power as in the second torque-speed relationship.

8. The method of claim 1, wherein a speed of movement of the vehicle is limited to a designated speed threshold while the propulsion system is operated according to the first torque-speed relationship.

9. The method of claim 1, further comprising automatically controlling the propulsion system to operate according to the first torque-speed relationship or according to the second torque-speed relationship.

10. The method of claim 1, further comprising determining one or more conditions of the vehicle, and controlling the propulsion system to operate according to the first torque-speed relationship or according to the second torque-speed relationship based on the one or more conditions of the vehicle.

11. A method comprising:
controlling a propulsion system of a vehicle to operate according to a first torque-speed relationship between a power generated by an engine of the propulsion system and a speed of the engine, the propulsion system controlled according to the first torque-speed relationship during acceleration of the vehicle by one or more motors that are powered by operation of the propulsion system;
determining one or more of a rate of acceleration of the vehicle, that the propulsion system has been operated for a predetermined amount of time, or that operation of the propulsion system has reached a steady state following the propulsion system operating according to the first torque-speed relationship; and
controlling the propulsion system to operate according to a second torque-speed relationship between the power generated by the engine and the speed of the engine based on determining the one or more of the rate of acceleration of the vehicle, that the propulsion system has been operated for the predetermined amount of time, or that operation of the propulsion system has reached the steady state, the second torque-speed relationship reduced relative to the first torque-speed relationship such that the engine speed in the first torque-speed relationship is associated with a greater amount of the power than in the second torque-speed relationship.

12. The method of claim 11, further comprising controlling the propulsion system to operate at a second engine speed of the first torque-speed relationship responsive to determining the one or more of the rate of acceleration of the vehicle, that the propulsion system has been operated for the predetermined amount of time, or that operation of the propulsion system has reached the steady state, wherein the second engine speed of the first torque-speed relationship is associated with a same amount of the power as in the second torque-speed relationship.

13. The method of claim 11, wherein the propulsion system is configured to reach the steady state in a reduced amount of time by controlling the propulsion system according to the first torque-speed relationship relative to controlling the propulsion system according to the second torque-speed relationship.

14. The method of claim 11, wherein the engine speed in the first torque-speed relationship is greater than a second engine speed in the first torque-speed relationship, and the engine speed in the first torque-speed relationship is associated with a greater amount of the power than the second engine speed in the first torque-speed relationship.

15. The method of claim 11, wherein a speed of movement of the vehicle is limited to a designated speed threshold while the propulsion system is operated according to the first torque-speed relationship.

16. The method of claim 11, further comprising automatically controlling the propulsion system to operate according to the first torque-speed relationship or according to the second torque-speed relationship.

17. The method of claim 17, further comprising determining one or more conditions of the vehicle, and controlling the propulsion system to operate according to the first torque-speed relationship or according to the second torque-speed relationship based on the one or more conditions of the vehicle.

18. A vehicle control system comprising:
a controller having one or more processors configured to control a propulsion system of a vehicle to operate according to a first torque-speed relationship between a power generated by an engine of the propulsion system and a speed of the engine, the controller configured to control the propulsion system to operate according to the first torque-speed relationship during acceleration of the vehicle system by one or more motors that are powered by operation of the propulsion system;
the one or more processors further configured to determine that operation of the propulsion system has reached a steady state following the propulsion system operating according to the first torque-speed relationship,
wherein the controller is configured to control the propulsion system to operate according to a second torque-speed relationship between the power generated by the engine and the speed of the engine, the second torque-speed relationship reduced relative to the first torque-speed relationship such that the engine speed in the first torque-speed relationship is associated with a greater amount of the power than in the second torque-speed relationship.

19. The vehicle control system of claim 18, wherein the one or more processors are configured to determine that the propulsion system has been operated according to the first torque-speed relationship for a designated threshold amount of time, and the controller configured to control the propulsion system to operate according to the second torque-speed relationship.

20. The vehicle control system of claim 18, wherein the controller is configured to control the propulsion system to operate at a second engine speed of the first torque-speed relationship responsive to determining that operation of the propulsion system has reached the steady state, wherein the second engine speed of the first torque-speed relationship is associated with a same amount of power as in the second torque-speed relationship.
